(19) United States
(12) Patent Application Publication
(10) Pub. No.: US 2004/0098670 A1
(43) Pub. Date: May 20, 2004

(54) Processing of data

(76) Inventor: Jeremy John Carroll, Livorno (IT)

Correspondence Address: HEWLETT-PACKARD COMPANY, Intellectual Property Administration, P.O. Box 272400, Fort Collins, CO, 80527-2400, US

(21) Appl. No.: 10/644,273

(22) Filed: Aug. 19, 2003

(30) Foreign Application Priority Data
Nov. 15, 2002 (GB) 0226697.1

(51) Int. Cl. G06F 15/00

(52) U.S. Cl. 715/517

(57) ABSTRACT

A method of canonicalizing an RDF graph having a plurality of blank nodes, the method comprising: generating a representation of the RDF graph and ordering the representation, the plurality of blank nodes being substantially omitted from the ordering process; assigning a label to each of a number of the plurality of blank nodes; modifying the portion of the blank nodes remaining unlabelled; and reordering the representation.

### BACKGROUND TO THE INVENTION

An example of a graphical form of data representation is a data model known as Resource Description Framework (RDF), which represents data in the form of a mathematical graph, that is to say a graph of nodes and directed arcs, and in doing so illustrates any interrelationship of different data attributes. In accordance with the terminology of the RDF data model, data is represented either as a Resource, a Property, or a Value. One of the values of representing data graphically is that, in theory it is possible to allow data thus represented to convey semantic meaning, and for this reason RDF is currently the leading candidate data model for providing the basis of a semantic Worldwide Web.

An RDF document describes both the data in a record, its nature and any interrelationship with data in another record. The purpose of representing data in such a manner is essentially to provide a common format independent of the source format of data, which may be manipulated by computers, and which contains the original data.

One feature of a semantic worldwide web that is currently perceived as being highly desirable is the ability to digitally sign data documents. A currently perceived key part of the digital signature process is performing an initial stage of canonicalization. Canonicalization is the processing of removing insignificant data that has no effect on the meaning of the data. For example, the colour of the paper on which a legal document is written or printed has no impact on the legal meaning of the document. Thus removal of any data relating to the colour of the paper is a canonicalization step. By performing canonicalization on data documents the insignificant differences are removed allowing two such documents to be compared with one another to verify that they contain the same information. Some apparently trivial differences may be significant: for example, if the document contains the phrase “As defined in paragraph 3.2,” then a step of renumbering the paragraphs may change the meaning of that phrase, since the old paragraph 3.2 and the new paragraph 3.2 may be different.

One of the problems associated with the graphical representation of data, which is a problem well known per se, is that limitations of current mathematical theory correspondingly limit the ability to process the data. For example, it is not within the scope of current mathematical theory to provide sufficiently fast algorithms which perform analytic rigorous topographical comparison between two graphs. Such limitations in turn limit the extent to which graphically represented data can achieve the aims of providing the basis of, for example, a semantic worldwide web.

### SUMMARY OF THE INVENTION

A first aspect of the present invention seeks, inter alia to ameliorate this problem, and provides a generally applicable method of processing data, which is applicable to the processing of graphically represented data.

According to a first aspect of the invention there is provided a method of processing data (typically, but not necessarily graphical data) according to which data is processed in accordance with a first set of rules, which operate, inter alia to define a stage at which such a processing operation ceases, and then applying to the partly-processed data a second set of rules, which operate to modify the data so that the data thus modified is then processable further by applying a third set of rules. In a preferred embodiment, modified data is then processed by the third set of rules.

Although the data which it is desired to process has itself been changed, because this change has taken place on the basis of a defined set of rules the outcome of these operations, and in particular the manner in which the outcome of the processing differs from an ideal (in which the unmodified data is processed completely), will be well understood. Different sets of data processed by applying this method may thus be compared, combined or otherwise used in conjunction with each other on this basis provided consistent rules are applied to their processing. In one preferred embodiment, the first and third sets of rules are similar, and in a further embodiment they are the same.

Preferably, in the method outlined above, the first set of rules perform a deterministic modification of the data. Deterministic modifications may, in layman's terms, be thought of as significant modifications which do not depend on insignificant parts of the document, as explained above. Conversely, non-deterministic modifications are significant modifications which may depend on insignificant parts of the document. That is, given a document A and B which differ only insignificantly and a deterministic process p( ) which modifies the document A to p(A) and B to p(B), then p(A) and p(B) differ only insignificantly. A nondeterministic process p( ) is one for which there are documents A, B, that differ only insignificantly for which p(A) and p(B) differ significantly.

Preferably modifications of the data following processing in accordance with the second set of rules is/are non-deterministic modifications (i.e. significant), but may be “labelled” as insignificant.

The RDF Concepts and Abstract Syntax Last Call Working Draft http://www.w3.org/TR/2003/WD-rdf-concepts-20030123/published by the World Wide Web Consortium (23 Jan. 2003, editors Klyne and Carroll), presents an abstract representation of the RDF graph. A possible explicit representation is that given in the N-Triples section of the RDF Test Cases Last Call Working Draft http://www.w3.org/TR/2003/WD-rdf-testcases-20030123/#ntriples published by the World Wide Web Consortium (23 Jan. 2003, editors Grant and Beckett).

According to a second aspect of the present invention there is provided a method of canonicalizing an RDF graph having a plurality of blank nodes, the method comprising generating a representation of the RDF graph and ordering the representation, the plurality of blank nodes being substantially omitted from the ordering process; assigning a label to each of a number of the plurality of blank nodes; making modifications concerning the portion of the blank nodes remaining unlabelled; and reordering the representation.

In a preferred embodiment the representation is an N-Triples document which is ordered in lexicographic order.

The modification of the unlabelled blank nodes may comprise deleting the blank nodes and all the triples in which they participate. Alternatively, the modification may comprise adding data to the representation of the RDF graph such that the remaining unlabelled blank nodes can be labelled and labelling those blank nodes accordingly.

Either the first or second aspects of the present invention may be implemented as a computer program. The program is preferably embodied on a computer readable medium, or alternatively is carried on an electrical carrier signal.

A more detailed description of an embodiment of the present invention, given by way of illustrative example only, will now be provided with reference to the accompanying figures, of which:

### BRIEF SUMMARY OF THE DRAWINGS

FIG. 1 shows a tabular representation of two conventional database entries;

FIG. 2 shows the RDF representation of the entries shown in FIG. 1; and

FIG. 3 shows a further RDF graph.

### DETAILED DESCRIPTION OF EMBODIMENTS OF THE INVENTION

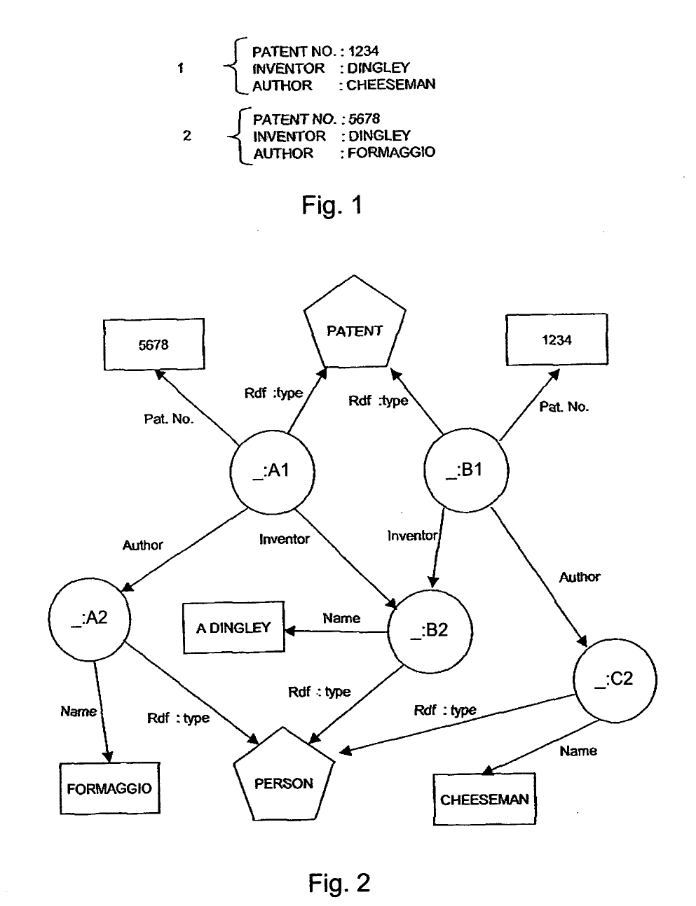

Referring now to FIG. 1, two records whose data it is desired to store in a database are illustrated. Each record has three attributes: the publication number of a patent, the inventor designated on the patent, and the author of the specification of the patent. As can be seen from looking at the records, the inventor in each case is the same, and so to this extent at least, the two records are interrelated.

Referring now to FIG. 2, both records, and their interrelationship can be represented in a graphical document format known as Resource Description Framework (RDF), and an RDF document representative of the two records is shown in FIG. 2. The RDF document may be thought of as graphical representation of the data in FIG. 1, which also describes the structure of that data, and contains essentially three elements: Resources, Properties and Values. Thus for example, the document in FIG. 2 has a resource _:A1. This Resource is labelled _:A1. This label is known as a blank node identifier. In the event that the resource is named by a Uniform Resource Indicator (URI), such as for example a web page address, this would appear instead, as the name of the Resource. In this example the resource has no such name, and the node is known as “blank”, but has four different properties which, inter alia serve to characterise it: Patent No., Author, Inventor (all of which may intuitively be related to one of the records in FIG. 1), and “rdf: type”. The first three properties are simply the different attributes of one of the records shown in FIG. 1, while the fourth indicates the type or nature of the Resource, which in this instance is a patent. With this in mind it follows that a patent (which is the “type” of the Resource) has the properties of Author, Inventor and Number, and while this may not be the most intuitive way to describe a record in FIG. 1 from a lay person's perspective, it nonetheless is possible to see that all of the information shown in a record in FIG. 1 is replicated in this format. Thus the two Resources _:A1 and _:B1 relate to the patents 5678 and 1234 respectively. The choice of blank node identifiers is insignificant. That is, changing the blank node identifiers in an RDF graph does not change its meaning. For nodes labelled with URIs, the choice of these labels is significant. Changing URI labels does change the meaning of the graph. These differences in meaning are detailed in the RDF Semantics Working Draft of 23 Jan. 2003, edited by Pat Hayes, and published by the World Wide Web Consortium.

The properties of Inventor and Author for each of these two Resources are respectively represented by further Resources: _:B2 which corresponds to the inventor—since the inventor is the same in each case; and _:A2 and _:C2 which correspond to the two authors.

The Resource _:B2 is thus the Value of the Inventor Property for each of the Resources _:A1 and _:B1, and itself has two further properties, one of which is its rdfs: type, indicating that the Inventor is a person, and the other is the name of the inventor, which is its “literal” Value, the inventor's name A. Dingley. The Author Properties of the Resources _:A1 and _:B1 are respectively the Resources _:A2 and _:B2 and each have an rdfs: type property which signifies that the Author is a person, and Name Properties having literal Values, which are the names of the Authors “Formaggio” and “Cheeseman” respectively.

The graphical RDF document shown in FIG. 2 can be expressed in a purely alphanumeric text file. This is done by taking each edge, which corresponds to the line arrows shown in FIG. 2, and defining what is at one end of the line, what is at the other end of the line and what the line represents. For example, consider the edge “pat.no.” between the resource _:A1 and the value 5678. This can be represented as _:A1<pat. no.>5678 “pat.no.”. This representation is referred to as a “triple”. Equally, the same triple can be expressed as 5678 _:A1 “pat.no.”. In practice, both forms of the triple are included in the RDF triple file.

Additionally, RDF does not specify any ordering of the triples. Therefore, an RDF graph may be represented as two different files of triples, even though the graph they describe is the same. Some differences between the files are insignificant. These include any additional comments, the presence or absence of spaces between the elements of each triple, the order of the triples in the file and the choice of blank node identifiers. Other aspects of the triples are significant in that they represent the intended abstract RDF graph. Significant aspects include the presence or absence of a triple, the string in each literal and the URIs for each property or resource. By canonicalizing the RDF there is at most one representation of the RDF graph. It therefore becomes possible to check that any two RDF files are the same by converting both into canonical RDF and doing a character-by-character comparison.

Of the insignificant differences highlighted, only two present any interesting difficulties, the order of the lines and the blank node identifiers. A blank node is a node which is not identified by a Uniform Resource Indicator (URI) or a literal string. Its name is not important. For example, in FIG. 2 the nodes labelled _:A1, _:B1, _:A2, _:B2 and _:C2 are all blank nodes as they do not have URI labels which convey some meaning (see RDF Semantics, by Pat Hayes) but are merely convenient labels.

According to an embodiment of the present invention a first step in the canonicalization of an RDF file is to reorder the lines in the triples document to be in lexicographic, or dictionary order. If the triples file did not include any blank nodes then this would completely canonicalize the triples file. However, the presence of blank nodes in the triples file poses certain problems. In the triples, blank nodes are represented using blank node identifiers that are arbitrary labels created during the writing of the triples file and are not an intrinsic part of the RDF graph. Hence, it is erroneous if the canonicalization depends on these arbitrary labels. Therefore, according to an embodiment of the present invention the triples files are sorted by ignoring the blank node identifiers.

On the basis of the sorted triples document a number of the blank nodes may be renamed in such a fashion to allow the reordering process to be completed. For example, referring to FIG. 2, both nodes _:A1 and _:B1 are blank nodes. To allow the blank nodes to be renamed in a non-arbitrary manner to allow reordering to occur, some feature must be determined that distinguishes between the two blank nodes. In the example shown in FIG. 2, we can distinguish between the nodes _:A1 and _:B1 by looking at the most immediate edges in which they participate. By doing this we can discern that node _:A1 participates in the edge “pat.no” that has a value 5678, whereas node _:B1 participates in the edge “pat.no” that has the value 1234. It is then possible to reorder nodes _:A1 and _:B1 in accordance with this difference. For example node _:B1 may be relabelled “Arthur” and node _:A1 relabelled “Bert”, on the basis that the patent number value 1234 associated with _:B1 is numerically lower than the patent number value 5678 associated with _:A1. Once all such blank nodes have been relabelled the triples file is reordered again to produce the canonical form.

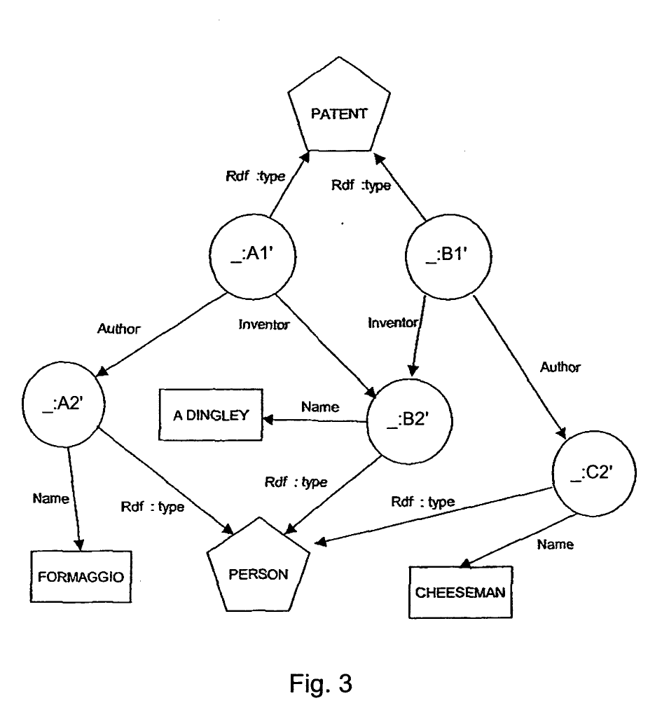

However, some blank labels will remain indistinguishable from one another and therefore it will not be possible to relabel them. FIG. 3 illustrates an RDF graph including two such blank nodes. The RDF graph shown in FIG. 3 is identical to that shown in FIG. 2, with the exception that the nodes _:A1′ and _:B1′ do not have a patent number resource or value associated to them as they do in FIG. 2. Consequently, the blank nodes _:Al′ and _:B1′ are indistinguishable from one another if the same process steps described above with reference to FIG. 2 are performed. These blank nodes can be referred to as “hard to label” nodes. It will be appreciated that, in fact, such “hard to label” blank nodes may be distinguishable from one another if a more complex comparison is made. For example, rather than limit the comparison to those edges which the node is directly involved in, all the edges that are two steps removed from the blank node are also considered. In this scenario, it would be possible to distinguish between the blank nodes _:A1′ and _B1′. The number of steps, or levels, at which the comparison between blank nodes is made may be determined either by the user, or by the canonicalization application itself and may depend on such factors as the processing power available on the platform on which the canonicalization application is being performed. There is extensive relevant literature on the graph isomorphism problem. A survey is found in Scott Fortin, The Graph Isomorphism Problem, Technical Report TR 96-20, Department of Computer Science, University of Alberta, 1996. ftp://ftp.cs.ualberta.ca/pub/TechReports/1996/TR96-20/TR96-20.ps.gz. It will be appreciated that other techniques from this literature could be used at this point. For any graph all hard-to-label nodes could be adequately distinguished using such techniques, but all known techniques which can label all nodes in all graphs are of exponential complexity. Rather than use an exponential algorithm the algorithms used in this invention have a defined stage at which the processing of labelling nodes ceases, which is hence constrained to be of low complexity (i.e. O(nlog(n)).

According to first embodiments of the present invention, having identified the “hard to label” blank nodes the next step is to simply delete all the “hard to label” nodes from the RDF graph. This involves deleting all the triples in which such nodes participate. None of the deleted triples will be distinctive, because if they were, the blank nodes in them would have been distinguishable and would have been labelled. Provided that the number of blank nodes that are deleted is only small, this method provides a good practical solution enabling canonicalization of the RDF graphs. In particular, this method allows the verification of the long term integrity of digital deposits where the entire meaning of those digital deposits does not need to be canonicalized, as long as the greater part is captured in the canonicalization. The number of blank nodes that it is deemed to be acceptable to delete may be user defined or may be automatically determined.

Other applications of the use of digital signatures require that the meaning of the document is fully captured in the object that is signed. Hence the deterministic approach of deleting undistinguished or blank nodes is unsatisfactory, since the meaning of the document is changed. According to second embodiments of the present invention distinctive triples are added to ensure that none of the nodes are “hard to label”. Therefore, the method comprises, after identifying the “hard to label” nodes, creating additional distinctive triples for those nodes and then deterministically labelling the resulting RDF graphs. Referring back to FIG. 3, this would involve adding an edge to both _:A1′ and _:B1′ that has an arbitrary value, thus allowing the blank nodes _:A1′ and _:B1′ to be distinguished from one another.

In further embodiments of the present invention, the canonicalization application may apply one or the other of the above mentioned schemes, i.e. deleting blank nodes or adding edges to blank nodes, in accordance with the previous filing criteria. For example, the number of “hard to label” blank nodes may determine which of the two schemes is applied.

An application scenario in which the addition of edges to “hard to label” blank nodes is particularly useful is that of signing an OWL ontology (which may be represented in an RDF graph). The ontologist creates the RDF graph representing the ontology in a software tool, and then asks that tool to generate a digital signature using a private key. The tool first applies the canonicalization method according to embodiments of the present invention, creates a canonical RDF graph with the same meaning as the original ontology, computes the signature for the canonical RDF graph and then adds one or more additional triples to the graph; eg one with the ontology URI as the subject and the signature as the object and possibly others with data relating to the manner of signature. This results in a graph (with additional triples both as a result of the canonicalization and the reflection of the signature) that is used to replace the original ontology. It is this graph, which can be canonicalized without any changes, that is published. Users of this published graph can then find the signature in the graph, find the public key using some public key infrastructure, delete the triples carrying the signature from the graph, apply the labelling scheme according to embodiments of the present invention to form a canonical representation of the graph and then verify their signature of this canonical RDF using the public key. It is of course possible to transmit the signature separately.

An example of embodiments of the present invention implemented in a Unix environment is described hereinafter.

The techniques in embodiments of the present invention rely on being able to make meaningless changes to an RDF graph. This is done in accordance with the RDF formal semantics, by using a special property, which arbitrarily referred to as c14n:true, defined whereas:

<rdf:RDF

xml:base=“&c14n;”
xmlns:c14n=“&c14n;#”
>

<rdfs:Property rdf:ID=“true”>

<rdfs:description>

This property is true whatever resource is its subject, and whatever literal is its object.

Thus triples with literal objects, and c14n:true as predicate, can arbitrarily be added to and deleted from an RDF graph without changing its meaning.

</rdfs:description>

</rdfs:Property>

</rdf:RDF>

The entity declaration and the declarations of the rdf and rdfs namespaces have been omitted.

By specifying this predicate as being always true, adding or deleting triples with this predicate does not alter the entailments under the RDF model theory. Formally the semantics of the document are unchanged.

To create a canonical N-Triples file for an RDF graph without any blank nodes the following algorithm may be used:

1. Canonicalize each XML Literal in the graph using XML canonicalization.

2. For each typed literal in the graph canonicalize it according to the rules in XML Schema datatypes. That is, given a typed literal <datatypeURI, lexicalForm> replace it with <datatypeURI, lexicalForm′>, where lexicalForm′ is the canonical from of lexicalForm according to the datatype specified by datatypeURI.

3. Write the graph as an N-Triples document. Each line of the document is a complete distinct triple of the graph.

4. Reorder the lines in the N-Triples document to be in lexicographic order. (This could be implemented simply with Unix™ sort).

If there are blank nodes in the graph then the situation is more complex. In N-Triples blank nodes are represented using blank node identifiers, which can appear in subject or object position. Unfortunately, these identifiers are gensyms created during the writing of the N-Triples, and are not an intrinsic part of the graph. Hence, it is an error if the canonicalization depends on these gensyms. In contrast, the canonicalization algorithm must deterministically choose new blank node identifiers.

In this part of the approach, the file is first written out using arbitrarily chosen blank node identifiers. The document is then sorted (mostly) ignoring those identifiers. On the basis of this sorted document, all the blank nodes are renamed, in a (hopefully) deterministic fashion.

Since the level of determinism is important to the workings of the canonicalization algorithm, a starting point is to define a deterministic blank node labelling algorithm. This suffers from the defect of not necessarily labelling all the blank nodes.

Deterministic, in this context, means dependent only upon significant parts of the initial representation of the graph, and nondeterministic means dependent, in part, upon insignificant parts of the initial representation of the graph.

In RDF, a single triple can contain zero, one or two blank nodes (the property must be specified by a URI). The one-step deterministic labelling algorithm presented below labels some blank nodes on the basis of the immediate neighbours of that blank node (the one-step in the name of the algorithm).

The previously defined algorithm is modified as follows:

1. Canonicalize each XML Literal in the graph using XML canonicalization.

2. For each typed literal in the graph canonicalize it according to the rules in XML Schema datatypes.

3. Write the graph as an N-Triples document. Each line of the document is a complete distinct triple of the graph.

4. For each line with a blank node identifier in subject position (e.g. _:subj), replace the blank node identifier with “˜” and add a comment “# _:subj” to the end of the line, indicating the original identifier.

5. For each line with a blank node identifier in object position (e.g. _:obj), replace the blank node identifier with “˜” and add a comment “# _:obj” to the end of the line, indicating the original identifier.

6. Reorder the lines in the N-Triples document to be in lexicographic order. (This could be implemented with Unix™ sort).

7. Use a gensym counter, initialized to 1, and a lookup table, initially empty. Go through the file from top to bottom:

a. If this line is the same as the next or previous line excluding any trailing comment, continue to the next line in the file.

b. If there is a “˜” in object position:

ii. Extract the blank node identifier from the final comment in the line. Remove the comment.

iii. Look the identifier up in the table.

iv. If there is no entry, insert a new entry formed from “_:g” concatenated with the current gensym counter value. Increment the counter.

v. Replace the “˜” with the value from the table.

a. If there is a “˜” in subject position, use the same subprocedure to replace it with a consistently chosen gensym.

8. Using the same lookup table. Go through the file from top to bottom:

a. If there is a “˜” in object position:

ii. Extract the blank node identifier from the final comment in the line. Remove the comment.

iii. Look the identifier up in the table.

iv. If there is an entry, replace the “˜” with the value from the table.

a. If there is a “˜” in subject position, use the same subprocedure to possibly replace it with a consistently chosen gensym.

9. Lexicographically sort the N-Triples again.

The only non-determinism present is that the sort may depend on the blank node labels in pairs of triples for which the rest of the triple is identical. Such pairs are thus avoided in the assignment of labels, and so the order in which such pairs appear does not effect the labels chosen. Notice that step 8, which does deal with the incomparable lines, does not choose any labels and is hence deterministic.

The algorithm will deterministically label some of the blank nodes, for others it leaves them unlabelled. These nodes are referred to as hard to label nodes.

The operation of the deterministic labelling algorithm depends on triples that can distinguish one blank node from another. These distinctive triples are characterized by being unique in the graph even when all blank nodes are treated as identical. The hard to label nodes do not participate in any distinctive triples.

The algorithm above has the desired property of being of a low complexity class, and hence optimizable to be sufficiently quick. Thus we will define canonical RDF on the basis of this algorithm as being an N-Triples document (without any comments) which is unchanged under the application of the one-step deterministic labelling algorithm.

That is canonical RDF in N-Triples has the following features:

There are no hard to label nodes.

Every blank node identifier has the form GNNN where NNN is some number of digits. The number of the digits is the same for every blank node identifier. At least one identifier has a non-zero first digit.

After deleting all triples which are not distinctive, the first occurrences of each blank node identifier appear in numeric order, starting at 1, without gaps.

The file is in lexicographic sort order.

Such files are unchanged under the one-step deterministic labelling. If one-step deterministic labelling successfully labels all the nodes, then the resulting output will be canonical RDF. In such cases, one-step deterministic labelling is idempotent. So the resulting file is in canonical RDF.

The one-step deterministic labelling algorithm above is sufficiently quick, being O(nlogn), and it is therefore desirable to make the algorithm useable in all cases: i.e. instead of looking for an algorithm that completely solves the RDF graph canonicalization problem, modify the problem to be soluble by the algorithm. This is done, in embodiments of the present invention, by ensuring that there are no hard to label nodes. As described previously, there are two ways of modifying the graph to make a deterministic labelling algorithm work.

The simpler approach is to delete all hard to label nodes from the graph. This involves deleting all the triples in which such nodes participate. None of those deleted triples will be distinctive, because if they were, then the blank nodes in them would have been labelled.

The modified algorithm is thus:

A. Perform the one step deterministic labelling.

B. Delete all lines containing a “˜” in subject or object position.

Note that this procedure is deterministic and idempotent.

Deleting unlabelled nodes appears drastic, but as long as there are few (e.g. zero) of these nodes, it is a good practical solution.

For applications where there is desire to capture the essence of a digital object despite reformatting this is a good fit. This allows verifying the long-term integrity of digital deposits, where the entire meaning does not need to be canonicalized, as long as the greater part is captured in the canonicalization.

Other applications of the use of digital signature require that the meaning of the document is fully captured in the object that is signed. An example would be signing a purchase order. Hence the deterministic approach above is unsatisfactory, since it changes the meaning of a document.

The second approach adds distinctive triples in order to make sure that none of the nodes are hard to label.

The version described here uses many passes of the file—the three important passes:

1. Identify the hard to label nodes;

2. Create additional distinctive triples for those nodes

3. Deterministically label the resulting graph.

In the preliminaries a ready supply of meaningless triples (with predicate c14n:true) is arranged that can be added to and deleted from the graph without modifying its meaning.

Thus, we can perform the following steps:

A. Perform a one-step deterministic labelling.

B. If there are no hard to label nodes, then stop. [This step is to ensure the algorithm is idempotent].

C. Delete all triples with predicate c14n:true. [Without B this would not be idempotent]

D. Perform a one-step deterministic labelling.

E. Using a new lookup table from step D, and a new counter, scan the file from top to bottom, performing these steps on each line:

a. If there is a “˜” in object position:

ii. Extract the blank node identifier from the final comment in the line. Remove the comment.

iii. Look the identifier up in the table.

iv. If there is no entry: add an entry “x” to the table; and add a new triple to the graph with subject being the blank node identified by the identifier from the comment, predicate being c14n:true and object being the string form of the counter; increment the counter.

a. If there is a “˜” in subject position, use the same subprocedure to possibly create a distinctive triple for the subject as well.

F. Perform a one-step deterministic labelling (of the new modified graph, with a new lookup table and counter). Since all nodes participate in a distinctive triple, every table lookup will find an entry.

This cheating algorithm is non-deterministic in step E, but that non-determinism is fairly limited, because even with the rather naïve one-step deterministic labelling algorithm almost all nodes in almost all (practically occurring) RDF graphs will have been classified. An application scenario in which this is useable is that of signing an OWL ontology. The ontologist creates the ontology in a tool, and then asks the tool to generate a signature using a private key. The tool:

1. Applies this algorithm, possibly adding additional triples to the ontology.

2. Creates a canonical RDF graph with the same meaning as the original ontology.

3. Computes the signature for the canonical RDF graph.

4. Adds additional triple(s) to the graph with the ontology URI as subject, and the signature as object.

The resulting graph (with additional triples both as a result of canonicalization and reflecting the signature) then replaces the original ontology. It is this graph (which can be canonicalized without any changes) that the ontologist publishes. Users of this ontology can then:

1. find the signature in the graph.

2. find the public key using some public key infrastructure

3. delete the triple(s) carrying the signature from the graph.

4. apply the deterministic labelling to form a canonical representation of the graph

5. verify the signature of this canonical RDF using the public key.

APPENDIX I
Unix and GNU awk (version 3.0.3) partial implementation

| ================== | | |
|---|---|---|
| == README | | |
| ================== | | |
| 1 | | |
| 2 | | |
| 3 | This directory contains a prototype implementation | |
| 4 | of the techniques described in RDF Canonicalization: | |
| 5 | A Cheater's Guide by Jeremy J. Carroll. | |
| 6 | | |
| 7 | The implementation requires Ntriple files as input | |
| 8 | and outputs Ntriple files in canonical RDF. | |
| 9 | | |
| 10 | The treatment of space in literals does not | |
| 11 | conform with the lexicographic order in the paper; | |
| 12 | spaces are sorted as the character sequence “\u0020”. | |
| 13 | | |
| 14 | The files are: | |
| 15 | aline | - A file with two or more blank lines. |
| 16 | c14n.awk | - An awk script implementing steps 7 and 8 |
| 17 | | from the one step deterministic labelling. |
| 18 | escape-space.sed | |
| 19 | | - a sed file for removing spaces from literals |
| 20 | | in Ntriple files. (They are replaced with |
| 21 | | the illegal escape sequence \u0020) |
| 22 | multipass.awk - An awk library to allow multiple passes | |
| 23 | | over the datastream in a single awk process. |
| 24 | multistep.awk - An awk script that initializes a one or multi | |
| 25 | | step deterministic labelling, using the |
| 26 | | c14n.awk and multipass.awk libraries. |
| 27 | multistep.sh - A shell script that invokes the sed and awk | |
| 28 | | scripts appropriately - start here. |
| 29 | multistepdelete.sh - A shell script that turns arbitrary | |
| 30 | | Ntriples into canonical RDF by deleting |
| 31 | | the unlabelled nodes after a multistep |
| 32 | | labelling. |
| 33 | | |
| 34 | | |

==================
== aline
==================
1
2
3
4
5

====================
== c14n.awk
====================
1
2

| | |
|---|---|
| 3 | # This file defines the following awk passes that |
| 4 | # can be used with the multipass.awk library. |
| 5 | # “step7” in the one-step deterministic labelling. |
| 6 | # “step8” in the one-step deterministic labelling. |
| 7 | |
| 8 | { dType = 0 |
| 9 | dSame = 0 |
| 10 | } |
| 11 | $1 == “˜” { dType +=1 } |
| 12 | $3 == “˜” { dType +=2 } |
| 13 | PASS == “step4” && $1˜/\hat{ }_:/ { $(NF+1) = “#” |

| | |
|---|---|
| 14 | $(NF+2) = $1 |
| 15 | $1 = “˜” |
| 16 | } |

| | |
|---|---|
| 17 | PASS == “step5” && $3˜/\hat{ }_:/ { $(NF+1) = “#” |

| | |
|---|---|
| 18 | $(NF+2) = $3 |
| 19 | $3 = “˜” |
| 20 | } |

| | |
|---|---|
| 21 | PASS == “step4” { print > tmp } |
| 22 | PASS == “step5” { print > tmp } |
| 23 | PASS == “deleteSome” && ( $1 == “˜” \|\| $3 == “˜” ) { print > tmp } |
| 24 | PASS == “step7” && FNR != 1 && dType != 0 { |
| 25 | dSame = dLastType!=0 && ( dLast[1] == $1 && dLast[2] == $2 && dLast[3] == $3 ) |
| 26 | } |
| 27 | PASS == “step7” && FNR != 1 && dLastType != 0 { |
| 28 | if ( (!dSame) && (!dLastSame) ) { |
| 29 | numberVars() |
| 30 | } |
| 31 | } |
| 32 | PASS==“step7” { |
| 33 | printLast() |
| 34 | dLastSame = dSame |
| 35 | dLastType = dType |
| 36 | dLastLength = split($0,dLast) |
| 37 | } |
| 38 | PASS==“step8” { useNumberVars(); print > tmp } |
| 39 | AFTERPASS==“step7” { |
| 40 | if ( dLastType != 0 && (!dLastSame) ) { |
| 41 | numberVars() |
| 42 | } |
| 43 | printLast() |
| 44 | dLastLength = 0 |
| 45 | } |
| 46 | |
| 47 | function printLast( di) |
| 48 | { |
| 49 | if ( dLastLength != 0 ) { |
| 50 | for ( di = 1 ; di < dLastLength ; di ++ ) { |
| 51 | printf“%s ”,dLast[di] > tmp |
| 52 | } |
| 53 | printf“%s\n”,dLast[di] > tmp |
| 54 | } |
| 55 | } |
| 56 | |
| 57 | function numberVars() { |
| 58 | numberVar(3) |
| 59 | numberVar(1) |
| 60 | } |
| 61 | function numberVar(ix) { |
| 62 | if ( dLast[ix]==“˜”) { |
| 63 | name = dLast[dLastLength] |
| 64 | dLastLength-- |
| 65 | if ( !dTable[name] ) { |

| | |
|---|---|
| 66 | dTable[name] = sprintf(“%6.6d”,counter++) |

| | |
|---|---|
| 67 | } |
| 68 | dLast[ix] = “_:g” dTable[name] |
| 69 | if ( dLast[dLastLength] != “#” ) { |

| | |
|---|---|
| 70 | print “Shouldn't happen” > “/dev/stderr” |

| | |
|---|---|
| 71 | } else { |
| 72 | dLastLength-- |
| 73 | } |
| 74 | } |
| 75 | } |
| 76 | |
| 77 | function useNumberVars() { |
| 78 | useNumberVar(3,NF) |
| 79 | useNumberVar(1,6) |
| 80 | } |
| 81 | function useNumberVar(ix,pos) { |
| 82 | if ( $ix ==“˜”) { |
| 83 | if( !dTable[$pos] ) { |

| | |
|---|---|
| 84 | return |

| | |
|---|---|
| 85 | } |
| 86 | $ix = “_:g” dTable[$pos] |
| 87 | if ( pos == NF) { |

| | |
|---|---|
| 88 | NF = 2 |

| | |
|---|---|
| 89 | } else { |

| | |
|---|---|
| 90 | $pos = $(pos+2) |
| 91 | NF = 2 |

| | |
|---|---|
| 92 | } |
| 93 | } |
| 94 | } |

====================
== escape-space.sed
====================

| | |
|---|---|
| 1 | :retry |
| 2 | #sΛ(a[\hat{ }\\]“\)bΛ1\1/ |
| 3 | /\hat{ }#/d |
| 4 | sΛ(\hat{ }[\hat{ }“]*[\hat{ }\\]”\([\hat{ }\\”]\\|\\.\)*\) Λ1\\u0020/ |
| 5 | #sΛ([\hat{ }\\]“\([\hat{ }\\”]\|\\.\)*\) Λ1\\u0020/ |
| 6 | t retry |

====================
== fmtx
====================

| | |
|---|---|
| 1 | #!/bin/csh |
| 2 | foreach i ( $* ) |
| 3 | echo “====================” |
| 4 | echo “== ” $i |
| 5 | echo “====================” |
| 6 | pr -t -n $i |
| 7 | end |
| 8 | |

====================
== multipass.awk
====================

| | |
|---|---|
| 1 | # This is a library that allows the use of awk in |
| 2 | # multipass mode over stdin. |
| 3 | # use addPass(“foo”) to add an extra pass over |
| 4 | # the input. The pass is named “foo”. |
| 5 | # To print output for use in the next pass |
| 6 | # use print > tmp |
| 7 | # To access the name of the current pass |
| 8 | # use the variable PASS |
| 9 | # A special pass called “sort” maybe added, |
| 10 | # this sorts the data in lexicographic sort order |
| 11 | |
| 12 | |
| 13 | BEGIN { |

| | |
|---|---|
| 14 | tmp = “tmpA” |
| 15 | otherTmp = “tmpB” |
| 16 | ARGC = 1 |
| 17 | } |
| 18 | |

| | |
|---|---|
| 19 | { if ( DEBUG ) print FILENAME, ARGIND, passNames[ARGIND], $0 > “/dev/stderr” } |
| 20 | { AFTERPASS = 0 |
| 21 | if ( FNR == 1 && ARGIND % 2 == 0 ) { |

| | |
|---|---|
| 22 | AFTERPASS=PASS |

| | |
|---|---|
| 23 | } |
| 24 | } |
| 25 | { if ( FNR == 2 && ARGIND % 2 == 0) { |

| | |
|---|---|
| 26 | if ( passNames[ARGIND-1]==“sort” ) close(sort) |
| 27 | else close(tmp) |
| 28 | x = tmp |
| 29 | tmp = otherTmp |
| 30 | otherTmp = x |
| 31 | nextfile |

| | |
|---|---|
| 32 | } |
| 33 | } |
| 34 | { if ( FNR == 1 ) { |
| 35 | PASS = passNames[ARGIND] |
| 36 | if ( ARGC == ARGIND+2 ) tmp = “/dev/stdout” |
| 37 | if ( PASS == “sort” ) { |

| | |
|---|---|
| 38 | if ( ARGC == ARGIND+2 ) sort = “sort” |
| 39 | else sort = “sort > ” tmp |

| | |
|---|---|
| 40 | } |
| 41 | } |
| 42 | } |
| 43 | |
| 44 | PASS == “sort” { print \| sort } |
| 45 | |
| 46 | function addPass(passName, i) |
| 47 | { i = (ARGC + 1)/2 |
| 48 | passNames[ARGC] = passName |
| 49 | ARGV[ARGC] = ( i % 2 == 0 ? “tmpA” : “tmpB” ) |
| 50 | if (ARGC==1) ARGV[1]=“/dev/stdin” |
| 51 | ARGV[ARGC+1] = “aline” |
| 52 | ARGC += 2 |
| 53 | } |
| 54 | |
| 55 | |
| 56 | |
| 57 | |
| 58 | |

====================
== multistep.awk
====================
1

| | |
|---|---|
| 2 | # This implements the multistep and the onestep |
| 3 | # deterministic labelling algorithm from the |
| 4 | # paper RDF Canonicalization: A Cheater's Guide |
| 5 | # by J. Carroll. |
| 6 | |
| 7 | # The command line should be: |
| 8 | # awk -f multipass.awk -f c14n.awk -f multistep.awk [NN] < ntriples.nt |
| 9 | # [NN} is the desired number of steps (default one) |
| 10 | # ntriples.nt is the RDF graph as an ntriples file as input. |
| 11 | # Note spaces in literals are not supported. |
| 12 | |
| 13 | |
| 14 | BEGIN { |
| 15 | if (ARGC == 0) STEPS = 1 |
| 16 | else STEPS = ARGV[ARGC] |
| 17 | addPass(“step4”) |
| 18 | addPass(“step5”) |
| 19 | addPass(“deleteSome”) |
| 20 | addPass(“sort”) # step6 |
| 21 | for ( i = 0; i<STEPS; i++) { |
| 22 | addPass(“step7”) |
| 23 | addPass(“step8”) |
| 24 | addPass(“sort”) |
| 25 | } |
| 26 | } |

====================
== multistep.sh
====================

| | |
|---|---|
| 1 | #!/bin/sh |
| 2 | export LC_ALL= C |
| 3 | sed -f escape-space.sed \| awk -f multipass.awk -f c14n.awk -f multistep.awk $1 |

====================
== multistepdelete.sh
====================

| | |
|---|---|
| 1 | #!/bin/sh |
| 2 | export LC_ALL=C |
| 3 | ./multistep.sh $1 \| sed -e ‘/˜/d’ |

What is claimed is:

1. A method of processing data comprising the steps of:
processing data in accordance with a first set of rules, which operate, inter alia to define a stage at which such a processing operation ceases;
applying to the partly-processed data a second set of rules, which operate to modify the data, so that the modified data may be processed in accordance with a third set of rules.

2. A method according to claim 1 wherein the first and third sets of rules are the same.

3. A method according to claim 1 wherein the modification in accordance with the second set of rules modifies the data in a significant manner.

4. A method according to claim 3 wherein the first and third set of rules do not modify the data in a significant manner.

5. A method according to claim 1 wherein the data is graphically represented data.

6. A method according to claim 5 wherein the data is an RDF graph.

7. A method according to claim 1 wherein the first set of rules perform a deterministic modification of the data.

8. A method according to claim 3 wherein the significant modifications include the deletion of significant data.

9. A method according to claim 3 wherein the significant modifications include the addition of significant data.

10. Method according to claim 9 wherein the significant additions are distinguishable from data which is, prior to performance of any modifications, significant.

11. A method according to claim 1 wherein the data describes an ontology.

12. A method according to claim 1 further comprising the step of processing the data in accordance with the third set of rules.

13. A method according to claim 12, further comprising the step, subsequent to the processing of the data in accordance with the third set of rules, of writing or verifying a digital signature establishing authenticity of the data.

14. A method according to claim 1 wherein reapplying the method of claim 1 to data processed in accordance with such a method does not result in any further modification of the data.

15. A method of canonicalizing an RDF graph having a plurality of blank nodes, the method comprising:
generating a representation of the RDF graph and ordering the representation, the plurality of blank nodes being substantially omitted from the ordering process;
assigning a label to each of a number of the plurality of blank nodes;
modifying the portion of the blank nodes remaining unlabelled; and
reordering the representation.

16. A method according to claim 15, wherein the modification of the unlabelled blank nodes comprises deleting said blank nodes.

17. A method according to claim 15, wherein the modification of the unlabelled blank nodes comprises adding data to said representation such that the remaining unlabelled blank nodes can be labelled and labelling said blank nodes accordingly.

18. A method according to claim 15 wherein the representation is an N-Triple document and the ordering is in a lexicographic ordering.

19. A computer program comprising program instructions that, when loaded onto a computer, cause the computer to process data by:
processing data in accordance with a first set of rules, which operate, inter alia to define a stage at which such a processing operation ceases;
applying to the partly-processed data a second set of rules, which operate to modify the data, so that the modified data may be processed in accordance with a third set of rules.

20. A computer program according to claim 19 embodied on a computer readable medium.

21. A computer program according to claim 19 carried on an electrical carrier signal.

22. A computer program comprising program instructions that, when loaded onto a computer, cause the computer to canonicalize an RDF graph having a plurality of blank nodes by:
generating a representation corresponding to the RDF graph and ordering the representation, the plurality of blank nodes being substantially omitted from the ordering process;
assigning a label to each of a number of the plurality of blank nodes;
modifying the portion of the blank nodes remaining unlabelled; and
reordering the representation.

23. A computer program according to claim 22 embodied on a computer readable medium.

24. A computer program according to claim 22 carried on an electrical carrier signal.

25. A method of signing an RDF graph comprising the steps of: canonicalizing the graph by ordering triples from the graph and omitting blank nodes from the process of so ordering; and generating a signature in the form of a triple.

26. A method according to claim 25 further comprising the step of including the signature triple with other triples of the graph.
